(19) United States
(12) Patent Application Publication
(10) Pub. No.: US 2003/0208489 A1
(43) Pub. Date: Nov. 6, 2003

(54) Method for ordering parallel operations in a resource manager

(75) Inventor: Stephen J. Todd, Winchester (GB)

Correspondence Address: IBM Corp, IP Law,, 11400 Burnett Road, Zip 4054, Austin, TX, 78758, US

(73) Assignee: International Business Machines Corporation

(21) Appl. No.: 10/302,496

(22) Filed: Nov. 21, 2002

(30) Foreign Application Priority Data
May 2, 2002 (GB) 0210032.9

(51) Int. Cl. G06F 7/00

(52) U.S. Cl. 707/8

(57) ABSTRACT

A method for physically executing parallel operations in a resource manager (10) while retaining the effect of a defined logical serial ordering is provided. A plurality of operations is applied by a client application (16, 17, 18) to the resource manager (10). The method includes commencing a transaction between the client application (16, 17, 18) and the resource manager (10). The resource manager (10) receives a plurality of operations from the client application (16, 17, 18) in a logical order. The client application (16, 17, 18) indicates to the resource manager (100 that these operations can be applied in parallel. The resource manager (10) implements the operations in parallel and controls the parallel operations to ensure that the plurality of operations is executed such that the result of the parallel execution is the same as the result that would have been achieved by serial execution in the logical order. The transaction then ends.

### FIELD OF INVENTION

This invention relates to a method and apparatus for ordering parallel operations in a resource manager.

### BACKGROUND OF THE INVENTION

Resource managers include databases, messaging systems, and other forms of systems in which data is managed. Databases may include hierarchical or tree structure databases (for example, IMS®), network data structures, relational database systems (for example, DB2®, Oracle, Microsoft® SQL server, etc), object databases, and XML databases. Messaging systems may include messaging middleware (for example, MQSeries®). The term “resource manager” should be understood in a broad context including, but not limited to, all the above types of system. (IMS, DB2 and MQSeries are trademarks or IBM Corporation and Microsoft is a trademark of Microsoft Corporation).

In resource managers such as database systems, certain applications implement a sequence of database reads and updates with a very high expectation that all will work correctly. An example of such an application is a programming applying replicated data to a replication target database.

These applications frequently have to wait on database calls while the database reads information. This is always true for reading. It is often true for updating, as an update often includes only part of a row and the database implementation must read the full row before it can apply the update and rewrite the result.

In order to speed up database processing time, applications can be written to be multithreaded to provide parallelism within the database access. This is referred to as application controlled parallelism. In this way the data is read in the beginning and more than one request is carried out at the same time. This can result in the problem that if several requests are carried out simultaneously the wrong answer may be reached if the requests conflict with each other.

Writing applications in this way can be quite awkward, as the application is required to make an analysis of interdependencies in the update stream to prevent the processing of updates in an incorrect order.

Known application controlled parallel systems which use analysis of requests carried out by the application external to the database have the following disadvantages. The logical analysis is very difficult. Simple updates may trigger other unforeseen effects and deletions may result in cascaded deletes. On a physical level, databases may lock to prevent a wrong answer being returned and such a lock may be too coarse. Examples of coarse physical locking are given later.

The problem of read delays may also be partially handled by use of an asynchronous interface for SQL (Structured Query Language) calls. Structured Query Language is a database programming language that is only used to create queries to retrieve data from a database.

In an asynchronous interface each call may have an additional parameter, which is a pointer to an associated control block for reporting status and return information. Return information is handled by existing parameters.

Asynchronously requested results may be made available in one of three ways.

1. Synchronously on return from the call. (For example, where the request is invalid.)

2. On return from another call on the same database connection.

3. Completely asynchronously, with some form of event posting or callback.

Option (3) is more complicated to implement, requiring a more complicated interprocess communication (IPC) mechanism between the client (the application) and the server (the database). As the application will typically be issuing a stream of calls in any case, (2) will be adequate with no need to implement (3).

Various interfaces already exist for such asynchronous calls. However, most are limited to one outstanding call per connection. This allows application/database parallelism, but not parallelism of database operations for a single connection.

An example of an existing interface for asynchronous database calls is given at: http://support.microsoft.com/support/kb/articles/Q143/0/3 2.asp.

### DISCLOSURE OF THE INVENTION

It is an aim of the present invention to provide a method and apparatus that enable an interface for asynchronous operations, such as database calls or messages, that permit parallel operations on the same connection. It is a further aim to implement logical ordering of the operations based on a request order between calls implemented in parallel.

According to a first aspect of the present invention there is provided a method for ordering physically parallel operations in a resource manager, in which a plurality of operations is applied by a client application to the resource manager, the method comprising: commencing a transaction between the client application and the resource manager; the resource manager receiving a plurality of operations from the client application in a logical order; the client application indicating to the resource manager that these operations can be applied in parallel; the resource manager implementing the operations in parallel; the resource manager controlling the parallel operations to ensure that the plurality of operations is executed such that the result of the parallel execution is the same as the result that would have been achieved by serial execution in the logical order; and ending the transaction.

The resource manager may be a database system and the operations are read, write and update requests. Alternatively, the resource manager may be a messaging system and the operations are messaging operations.

In certain situations, the resource manager may complete a first operation before enabling a second operation to commence. On completion of a first operation holding a lock on a given resource, the resource manager may control an unlock of that resource that allows other operations in the same transaction and requiring a conflicting lock on that resource to commence.

A conflict between operations may be a physical locking conflict or a logical conflict. Locks on any resource may hold information on both the transaction and the order of the operation within the logical sequence.

Preferably, if a later operation in the logical order acquires a lock on a given resource before an earlier operation also attempts to acquire a conflicting lock on this resource, the resource manager detects a conflict.

In a first embodiment where conflict is detected, the resource manager may (a) back out of the later operation but does not back out the earlier operation or other operations within the transaction, (b) grant the lock to the earlier operation, (c) allow the earlier operation to run, and (d) rerun the later operation. The earlier operation may be run to completion before the later operation is rerun or, alternatively, the later operation may be rerun as soon as the lock has been granted to the earlier operation.

In a second embodiment where conflict is detected, the resource manager may back out all the work for all the operations in the transaction and rerun all the operations while ensuring that the conflicting operations are run in the correct logical order, wherein any reads may be read from the buffer of the resource manager.

In a third embodiment where conflict is detected, the resource manager may back out of the transaction and report transaction failure to the client application; the client application may then elect to rerun the transaction or take alternative appropriate action.

In any of the above embodiments where conflict is detected, if there are repeated conflicts, the resource manager may decrease the level of parallelism of operations.

Execution of the initial read part of each parallel operation prior to its first update part may be executed in parallel but update requests are executed in the specified logical order. As much data as possible may be read by the resource manager for each operation with a transaction before the update parts of these operations are processed.

An asynchronous interface may include a pointer for each operation to an associated control block for reporting status and return information. The results may be provided on return from another operation on the same server connection.

Operation status may be reported to the client application using an asynchronous callback or signalling mechanism.

The resource manager may be coordinated with other resource managers by a transaction coordinator. When a resource manager detects a conflict it may back itself out and recover by retry; but this is not reported to the coordinator, and no backout is executed of the overall transaction, or of the work already done by other coordinated resource managers.

According to a second aspect of the present invention there is provided a resource manager in which a plurality of operations within a transaction is applied by a client application to the resource manager, the resource manager comprising: receiving means for receiving a plurality of operations from the client application in a logical order, the client application indicating to the resource manager that these operations can be applied in parallel; means for implementing the operations in parallel and means for controlling the parallel operations to ensure that the plurality of operations is executed such that the result of the parallel execution is the same as the result that would have been achieved by serial execution in the logical order.

The resource manager may be a database system and the operations are read, write and update requests. Alternatively, the resource manager may be a messaging system and the operations are messaging operations.

The resource manager may comprise means for, in certain situations, completing a first operation before enabling a second operation to commence.

The resource manager may comprise means, responsive to completion of a first operation holding a lock on a given resource, for controlling an unlock of that resource that allows other operations in the same transaction and requiring a conflicting lock on that resource to commence.

A conflict between operations can, for example, be a physical locking conflict or a logical conflict.

In one embodiment, locks on any resource hold information on both the transaction and the order of the operation within the logical sequence.

In one embodiment, the resource manager comprises means, responsive to a later operation in the logical order acquiring a lock on a given resource before an earlier operation also attempts to acquire a conflicting lock on this resource, for detecting a conflict.

The resource manager may comprise means, responsive to detecting conflict, for (a) backing out of the later operation but not backing out the earlier operation or other operations within the transaction, (b) granting the lock to the earlier operation, (c) allowing the earlier operation to run, and (d) rerunning the later operation.

The earlier operation may be run to completion before the later operation is rerun.

The later operation may be rerun as soon as the lock has been granted to the earlier operation.

In one embodiment, the resource manager comprises means, responsive to conflict being detected, for backing out all the work for all the operations in the transaction and rerunning all the operations while ensuring that the conflicting operations are run in the correct logical order, wherein any reads can be read from the buffer of the resource manager.

In one embodiment, the resource manager comprises means, responsive to conflict being detected, for backing out of the transaction and reporting transaction failure to the client application; the client application may then elect to rerun the transaction or take alternative appropriate action.

In one embodiment, the resource manager comprises means, responsive to repeated conflicts being detected, for decreasing the level of parallelism of operations.

In one embodiment, execution of the initial read part of each parallel operation prior to its first update part is executed in parallel but update requests are executed in the specified logical order.

In one embodiment, the resource manager comprises means for reading as much data as possible for each operation with a transaction before the update parts of these operations are processed.

The resource manager may include an asynchronous interface with a pointer for each operation to an associated control block for reporting status and return information. The results of operations may be provided on return from another operation on the same server connection.

An asynchronous call back or signalling mechanism may be provided which reports operation status to the client application.

A transaction coordinator may be provided for coordinating the resource manager with other resource managers.

According to a third aspect of the present invention there is provided a computer program product stored on a computer readable storage medium for ordering physically parallel operations instructed by a client application, comprising computer readable program code means for performing the step of: controlling operations, in a transaction entered into between the client application and a resource manager, said plurality of operations being implemented by the resource manager in parallel, the operations being executed to ensure that the plurality of operations is executed such that the result of the parallel execution is the same as the result that would have been achieved by serial execution in the logical order.

### BRIEF DESCRIPTION OF THE DRAWING

An embodiment of the invention is now described, by way of example only, with reference to the accompanying drawing in which:

FIG. 1 is a schematic diagram of a database system in which the method and system of the present invention could be applied.

### DESCRIPTION OF THE PREFERRED EMBODIMENTS

A database is described as an example of a resource manager although, as stated above, other non-database resource managers may also use the method and system of the present invention.

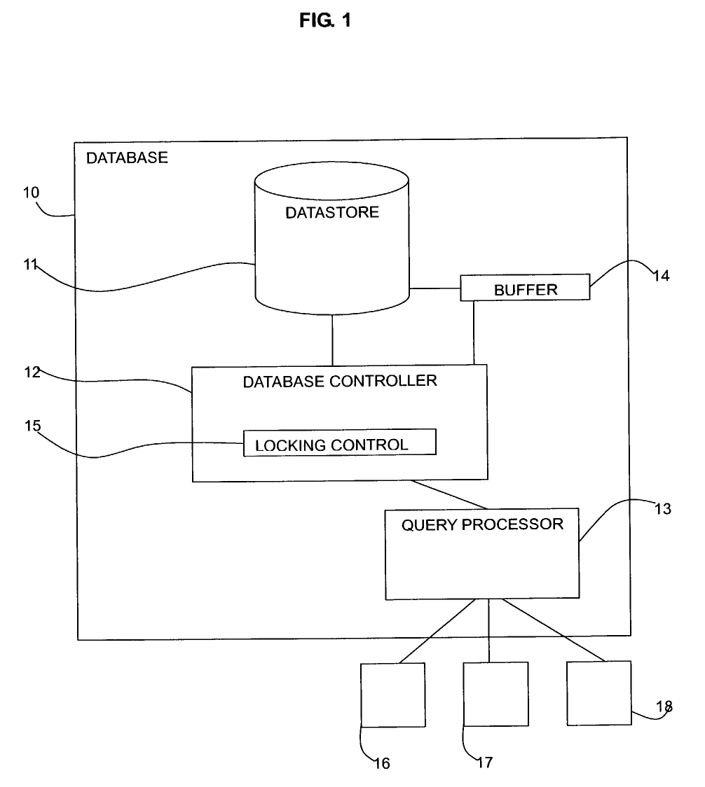

Referring to FIG. 1, a database 10 is shown which has a datastore 11 in which the data held in the database is stored. The database 10 includes a database controller 12, a query processor 13 and a buffer 14. The controller 12 includes a locking control 15 for locking areas of the datastore 11 and areas of the buffer 14 during accesses. Applications 16, 17, 18 which wish to access data in the database 10 make queries via the query processor 13.

In conventional systems, an application 16, 17, 18 accesses data in the database 10 by issuing an operation. An operation is implemented by the database 10 using the following simplified flow:

accept command

read data into buffers

lock

update buffers

return to caller

lazy write buffers (to log and to table store)

on prepare, force log

In the described method, a database operation has a different flow which can be shown as follows:

accept command

return to caller

read data into buffers

lock

update buffers

report asynchronously to caller

lazy write buffers (to log and to table store)

on prepare, force log

The above flow is the simple case, for more complex queries there may be more iteration over the read data into buffers, lock and update buffers especially if an update triggers other updates or in the case of cascaded deletes etc.

Databases and other resource managers typically implement the concept of transaction. This traditionally covers four areas (so called ACID properties), Atomicity, Consistency, Isolation and Durability (see for example http://www.cbbrowne.com/info/tpmonitor.html). The most important feature in this case is atomicity. The application marks the beginning and end of a transaction using special calls. The resource manager then ensures that either (a) all the operations carried out by the application during this transaction are applied, or (b) none of the operations applied during this transaction are applied.

During the life of a transaction, the application may request the resource manager to abort the transaction, in which case the operations applied so far are ‘backed out’ as if they never happened. Also, the resource manager may inform the application that it is impossible to complete the transaction, for example because of deadlock or some failure situation. Again, the operations applied so far are backed out. It is up to the application to reapply the operations of the transaction, or some suitable variant thereof, if deemed appropriate.

A transaction may involve a single database or other resource manager source, known as single phase. It may have more than one source, known as coordinated or two phase; this requires a transaction coordinator in addition to the coordinated set of resource mangers. This invention operates in either of these situations.

The described method takes advantage of the application defined transaction boundaries, and uses them as asynchrony boundaries to control the parallelism. This is natural for the application programmer used to transactions. Also, the normal transactional controls implemented by the resource manager (and transaction coordinator if applicable) are used with the modifications described below. These modifications are mainly involved with the extra Consistency issues of assuring logical ordering while implementing physical parallelism. The implementation of other Atomicity, Consistency, Isolation and Durability properties carries through unchanged.

Each transaction on the database has an identification (ID). In the described method the notation xid is used for an identification of a transaction.

If a transaction wants to read data from a database, the transaction applies a read lock to the relevant data in the database. A read lock prevents any other transactions from updating the data until the transaction with the lock has finished. More than one transaction can read the same data simultaneously and each transaction applies its own read lock.

If a transaction wants to write data to a database, the transaction applies a write lock to the relevant data. A write lock prevents any other transaction from reading or writing to the locked data until the lock is removed by the locking transaction.

Each lock is owned by a transaction. When the transaction completes, the lock is released. If a conflict arises between transactions due to locks, there are known methods in the prior art for resolving such conflicts.

In the described method, an application sends a sequence of operations in a single transaction. Each operation is assigned a sequence number within the transaction identification, so that each operation is labeled as to its sequence within a transaction. This helps control internal parallelism in the database.

In the described example, an operation has an identifier of xid/seq#—which means that the operation has sequence number # in transaction x.

If another transaction has a lock on data which needs to be accessed by an operation, then existing methods of dealing with conflicts between locks of transactions are used.

However, if an operation of a different sequence number but the same transaction has a lock on the data, the following described method is used to resolve the conflict.

The following options work on the assumption that for the majority of accesses conflict will not occur. If a conflict occurs, the database backs out and reruns the operations in the correct order. This form of parallelism in which operations run in parallel until a conflict arises, then the conflict is dealt with only at that time, results in a more time efficient method than both serial and application controlled parallel methods.

Option 1:

In option 1, locking is extended using each operation xid/seq# as an ‘owner’ of a lock where there may be more than one parallel operation in a transaction.

Interactions between different transactions, xid1 and xid2, are handled as known from conventional systems.

The following are options of actions to take when xid/seqx already holds lock and xid/seqy requests lock.

1a. If y<x there is a problem as seqy should have been carried out before seqx. The choice is as follows:

1a1. Back out database work for seqx, let y run, and rerun x.

This requires much more new work in database implementation. So it would be beneficial to keep track of the information to be able to do a partial back out for seqx.

1a2. Back out all database work, and rerun automatically within the database, making sure seqy is completed before seqx starts.

This is probably the preferred option. Everything in the transaction is wound back. Databases are always set up to be able to do this and therefore the method invokes existing database code. The back out is not too expensive, as most of required reading will now be in buffers. The database does not need to go back to the application, the database can just rerun the backed up data.

The rerun makes sure that the operations are in the correct sequence.

Parallelism has the aim of avoiding waiting for reading into buffers to complete. The reading to the buffers in this option has already been done before the need to back out. Therefore, the time expensive work has already been done and the backing out is not too time expensive.

1a3. Back out the complete transaction and warn application, it is then the application's responsibility to rerun the transaction.

This option may be simpler to implement, but slower and more work for the application. The database tells the application that it has got the sequence order wrong and that the application needs to re-instruct. This uses the conventional processing of a deadlock in which two applications try to do conflicting things and one must back out.

1ax. This is an extension to any 1a option, where repeated conflicts are found. This option automatically decreases parallelism in future.

This option can be used if back outs are being detected too often and time is being wasted. The system automatically reduces the degree of parallelism that the database attempts.

The proportion of time spent in options 1a is very low which means the overall system benefits from the parallelism of the cases in which conflict does not arise.

1b. If y>x. If the sequence is correct, the database must make sure that the first operation finishes its work before the second operation starts. This is the same effect as running sequentially. In this case there is a choice:

1b1. Wait until x completes before letting y continue.

Typically a database holds a lock until the end of the transaction, but this cannot be done in this case as there are other operations in the transaction. If the lock held by x and x is completely finished, then the database knows it can safely run y. The code running x in the database does not need to be changed.

1b2. Have x do ‘unlock local’ [change lock owner from xid/seqx to xid/0] when x has finished with the lock.

As soon as x knows its finished with a particular resource, it releases lock locally so that operations in the same transaction can start. This option requires changes in the database to effect the local unlock but more parallelism is obtained.

Option 2:

2. Parallelise read, but not update. This is an option that is cheaper to implement than Option 1 but is less beneficial.

2a. Only parallelise reads prior to the first write.

Reads are the main time consumers in database operations so a lot of time can be saved by parallelising the reads only. The database will not allow any operation to move onto the next processing steps until the previous operation is complete. In other words, the reads are carried out in parallel, but the remainder of the components of an operation are carried out serially. This may result in iterations in the remaining components of operations which have a conflict.

2b. Change internals to read as much as possible before any update.

This option guesses that data is not going to be updated and reads it in advance. When the operations are carried out in parallel, a double check is made as to whether the read was right. In other words, this requires a double check before using preread data, and some reread. (For example using the embodiment given below, move Dot to Sales, deductDotSalary, the wrong department may have been preread for deductDotSalary.)

This option involves more work to implement but has performance benefits over 2a.

Embodiments of the described options are given using an example of a simple database shown in Tables 1 and 2 of employee's salaries and departments.

TABLE 1
Employees

| Employee | Department | Salary |
|---|---|---|
| Sally | Sales | 100,000 |
| Sam | Sales | 80,000 |
| Dick | Development | 90,000 |
| Dot | Development | 90,000 |

TABLE 2
Departments

| Department | Balance |
|---|---|
| Development | 2,000,000 |
| Sales | 2,000,000 |

The following are examples of update queries which may be instructed.

U1: move Dot to sales;

U2: change Dot's salary to 95,000;

U3: increase Dot's salary by 5%;

U4: deduct Dot's salary from department balance;

U5: change Sam's salary to 85,000.

U6: increase Dot and Sam's salary by 5%

It will be readily noted that some of the above update queries conflict with each other and some are completely independent. For example:

U2 and U5 do not conflict. Logically U2 and U5 can be carried out in parallel. This is the case also at the physical level if row locking is used. However, if page locking is used, it is possible that a lock of information on a page for U2 will cause a conflict and force U5 to back out and to try again. This needs to be avoided for optimization of the process.

U1 and U2 are logically independent. They will be independent at the physical level if field locking is used. However, they will conflict at the physical level even with row locking: they cannot be done in parallel as the same row for Dot is needed for both updates.

U2 and U3 are dependent on each other and this would be noticed logically from outside the database system.

In the case of U1 and U4 it is difficult to resolve the conflict as the two updates are order dependent. If U1 is carried out first and Dot is moved to Sales, then U4 results in an update of the Sales department balance. If U4 is carried out first, the Development department balance will be changed before Dot is moved.

As seen from the above examples, conflict between operations is not easy to predict and therefore an application controlled parallel system may make erroneous predictions. In the described method, conflicts in parallel operations are handled by the database as they occur as detailed in the options above. Code using the described method will run inside the database and automatically respond to the actual physical locking of the database.

In the following diagrams, examples are shown for the prior art and the options of the described method detailed above. Prior art shown in these diagrams is ‘simple’, non-parallel prior art. The prior art of application controlled parallelism is not shown, as this is very dependent on implementation details of said application

The performance of the prior art of application controlled parallelism depends very much on how much knowledge the application has of database locking details, and can thus permit ‘suitable’ parallelism. The performance of application controlled parallelism will usually be close to that of the describe method, but:

a) It will never be better than the described method and will not always be close, for example, when it guesses wrong about locking.

b) The complex dependency analysis coding in the application in the prior art, at best, mimics the correctness achieved by the described method.

c) If incomplete dependency analysis is used in the prior art, there is a risk of the wrong answer being generated.

For simplicity, all the following diagrams assume row locking. As indicated in the examples above, there may be enhanced parallelism if field locking is used or worse parallelism if page locking is used, but the principle is not changed.

The following notation is used in the examples:

1 !—accept command

2 R.Dot—read Dot's record into buffers (or page containing Dot's record)

3 LR.Dot—read lock on Dot's row

LW.Dot—write lock on Dot's row

LU.Dot—‘local’ unlock of Dot's row (as in 1b2)

4 U.Dot—update Dot's record in buffer

5 W.Dot—start lazy write of Dot's record (or page containing Dot's record)

6 *—complete transaction—

--- indicates wait time for reading

=== indicates wait time for lock

??? indicates a thread that happens to get ‘behind’

# indicates recognition of ‘wrong order’ processing (case 1a).

The above notation is given for “Dot”. It will be appreciated that similar notation applies to the other records, for example, R.Dick, W.sales, etc etc

Each timing diagram is between the following lines:

--------------------------------------

--------------------------------------

Each row of timing diagram is a separate command on the list. Time moves from left to right. The final row T of each diagram indicates transaction.

### EXAMPLE 1

No logical conflicts, no physical conflicts.

This shows the general behaviour of serial prior art and options 1 and 2 in the simplest and commonest case.

Command list: U2 (change Dot's salary to 95,000), U5 (change Sam's salary to 85,000).

| | | |
|---|---|---|
| Ex1/PA: with prior art | | SEE |
| Ex1/1: with parallelism, option 1 | {close oversize parenthesis} | APPENDIX |
| Ex1/2: with parallelism, option 2 | | A |

### EXAMPLE 2

Physical conflict (due to row locking, even though no logical conflict).

This shows the effect of conflict in the serial prior art, and options 1 and 2. In this case, the second command does NOT try to jump over the first command. (eg Option 1b).

Command list: U1 (move Dot to sales), U2 (change Dot's salary to 95,000).

| | | |
|---|---|---|
| Ex2/PA: with prior art | | SEE |
| Ex2/1b1: with parallelism, option 1b1 | | APPENDIX |
| Ex2/1b2: with parallelism, option 1b2 | {close oversize parenthesis} | B |
| Ex2/2: with parallelism, option 2 | | |

Note reduced waiting for R.Dot for U2 in all parallel cases as the buffer is already being fetched with parallelism.

Ex2/PA is very similar to Ex1/PA, and Ex2/2 is very similar to Ex1/2. These cases were not attempting enough parallelism to be impacted by the conflict.

Ex2/1b1 and Ex2/1b2 are still better than Ex2/PA and Ex2/2, but because of the conflict the improvement is not as marked as in Example 1.

The benefits of 1b2 over 1b1 do not show up on this illustration, but see Example 5.

### EXAMPLE 3

Simple logical conflict.

This example shows the effect of conflict in serial prior art, and options 1 and 2. In this case the second command does NOT try to jump over first command (eg, option 1b).

Command list: U2 (change Dot's salary to 95), U3 (increase Dot's salary by 5%).

The picture will look exactly the same as Example 2. It is not important at the implementation level that the conflict was logical as well as physical. Once there is a conflict, it must be resolved.

It should be noted that unless there is a but in the database physical locking implementation, it is impossible to get a logical conflict with no physical conflict

### EXAMPLE 4

Simple logical conflict.

This case shows the effect of conflict in 1a1, 1a2, 1a3, where second command DOES try to jump over first command (eg, option 1a).

Because of the strict serial behaviour of the prior art, and stricter serial behaviour of option 2, there is no equivalent case.

The comparable behaviour of prior art and option 2 is exactly as for Examples 2 and 3.

Command list: U2 (change Dot's salary to 95,000), U3 (increase Dot's salary by 5%)

Ex4/1a1: with parallelism, option 1a1 - SEE APPENDIX C

This is a simple but artificial case. Random thread switching lets U2 get behind U3.

The problem is more likely to occur where the first command is more complex than the second, and has more initial R.xxx work to do. This is not illustrated as such illustration would be more complex and confusing and would not clarify the point any better.

The sooner the U2 thread gets control after the ???, the sooner it will detect the problem #. In this example, U2 got control after U.Dot. Similar pictures are possible where:

a) U3 gets the lock, but it is detected almost at once (before performing U.Dot). The lock must be taken from U3 and given to U2, but there is no significant undo to be performed on U3.

b) U3 also initiates W.Dot before detection. W.Dot has to be undone as well as undoing U.Dot.

| | | |
|---|---|---|
| Ex4/1a2: with parallelism, option 1a2 | | SEE |
| | {close oversize parenthesis} | |
| Ex4/1a3: with parallelism, option 1a3 | | APPENDIX D |

The first transaction dies completely, and a second transaction takes over (with help from the application, which resubmits the command list).

A similar scenario to all three cases above would apply even if there was no logical conflict, e.g. U1 (move Dot to sales), U2 (change Dot's salary to 95,000). Even though these could safely be applied in the ‘wrong’ order, the physical locking of the system is too course to recognize this. It will perform back out/retry processing as in Ex4/1a1, Ex4/1a2 and Ex4/1a3, even though this processing is not strictly necessary.

### EXAMPLE 5

Slightly more complex logical conflict.

This case shows the effect of the difference of 1b1 and 1b2. These are sub-cases of 1b, where the second command does NOT try to jump over first command.

Command list: U6 (increase Dot and Sam's salary by 5%), U2 (change Dot's salary to 95,000)

| | | |
|---|---|---|
| Ex5/1b1: with parallelism, option 1b1 | | SEE |
| | {close oversize parenthesis} | |
| Ex5/1b2: with parallelism, option 1b2 | | APPENDIX E |

The difference between 1b1 and 1b2 is clearer than in Example 2. In particular, U2 is completed much earlier If both U6 and U2 were more complicated but slightly conflicting, (eg U6 (update Dot and Sam), U7 (update Dot and Dick)) there would be much more parallelism in 1b2 than 1b1. This is not shown, because the illustrations (especially the 1b1 case) would be too wide.

An example of an implementation of the described method in SQL code is given below.

// -----------------------------------------
// New options defined by sql header files:
// -----------------------------------------
typedef enum { SQL_RUNNING, SQL_COMPLETE_OK, SQL_FAILED }
sqlstatus;
typedef struct SSQLASYNCCB {

| | |
|---|---|
| sqlint32 sqicode; | // sqlcode for final completion |
| sqlstatus asyncState; | // asynchronous state |

| | |
|---|---|
| } | SQLASYNCCB; |

#define SQLASYNCCB_DEFAULT {0, SQL_UNSET}

| | |
|---|---|
| SQLSYNCCB *SQL_FIRSTCOMPLETE; | //pointer to the first complete |
| operation | |
| | // (probably held as a member of sqlca) |

// -----------------------------------------
// -----------------------------------------
// NEW EXEC SQL calls
// -----------------------------------------

| | |
|---|---|
| EXEC SQL ASYNC (cb) sqlcall; | //this will perform sqlcall |

asynchronously

| | |
|---|---|
| EXEC SQL WAITALL (cb1, . . . ); | //this will wait till all listed |

operations complete

| | |
|---|---|
| EXEC SQL WAITANY (cb1, . . . ); | //this will wait until any |

listed operations complete

| | |
|---|---|
| EXEC SQL WAITANY; | //this will wait until any |

outstanding operation on connection complete
// -----------------------------------------
Example:
void test () {

| | |
|---|---|
| SQLASYNCCB | cb1=SQLASYNCCB_DEFAULT, |

cb2=SQLASYNCCB_DEFAULT,
cb3=SQLASYNCCB_DEFAULT;

EXEC SQL ASYNC (cb1) UPDATE1 . . . ;
EXEC SQL ASYNC (cb2) UPDATE2 . . . ;
EXEC SQL ASYNC (cb3) UPDATE3 . . . ;
EXEC SQL WAITALL;
if (cb1.SQLCODE) . . . error handling
if (cb2.SQLCODE) . . . error handling
if (cb3.SQLCODE) . . . error handling
EXEC SQL COMMIT;

};

Extension:

To save the client programming scanning for completed tasks, the server could produce information on each call about other, asynchronous call completed. For example, the number of such calls, a list of such calls, and a return code summary for such calls.

Add

| | |
|---|---|
| struct SSQLASUNCCB *pNextComplete; | // pointer to the next |

complete to SQLASYNCCB;
#define SQLASYNCCB_DEFAULT {0, SQL_UNSET, NULL}
And include as statically available data from each call (eg in
sqlca)

| | |
|---|---|
| sqlint32 SQL_ASYNCNUMCOMPLETE; | // number of async calls |

completed during execution of last call

| | |
|---|---|
| bool SQL_ASYNCOK; | // true if ALL async calls |

completed were OK

| | |
|---|---|
| SQLASYNCCB *SQL_ASYNCFIRSTCOMPLETE; | // pointer to control |

block for the first complete async call

It will be clear to one skilled in the art that there are many other mechanisms to report back asynchronous completion to the application. For example, a specific interface may be provided for the application to poll, or a callback mechanism may be implemented. In many cases the application will not be interested in details, and will be content with the (normal) successful return of the transaction completion operation, with (occasional) error returns such as Rollback, In any case, the details by which the status of parallel operations is reported back to the application will not significantly impact the implementation detail of the parallel operation.

The above description relates to resource managers in the form of database systems. The described method can also be applied in other areas such as messaging systems. In a messaging system, it may be desirable to write several messages in parallel.

In messaging systems, updates of messages are not carried out, a new message is simply written. So there is no reading step before an update and therefore no reading delay. Messaging systems are also different in that messages are usually read from the beginning or end of a queue. In database systems, it cannot be anticipated where a read will happen. Therefore, in messaging systems the beginning or end of the queue can already be in the buffer ready for reading. For these reasons, the invention is likely to be more advantageous to database systems than to messaging systems.

The method described above of dealing with conflicts between operations in a database system, could be applied to operations in the form of messages in a messaging system, as both use similar underlying locking techniques.

There are some differences. For example, messaging systems do not typically make detailed assurances about the ordering of messages written by different parallel transactions, but require that messages written within a transaction are saved and (subsequently returned to other transactions) in the order written. Messaging systems do not therefore typically need to hold locks on queues between one write operation and another; the operations within one transaction occur sequentially and fall naturally into order, and there is no ordering between transactions. However, it will be necessary to hold such write locks in order to support this invention, to assure appropriate sequencing between operations implemented in parallel by a single transaction. These locks will behave as for databases when potential conflicts occur within a transaction (xid/seqx and xid/seqy), but NO action will be taken for potential conflicts between transactions (xid1/seqx and xid2/seqy).

Improvements and modifications can be made to the foregoing without departing from the scope of the present invention.

[image]

[image]

[image]

[image]

[image]

What is claimed is:

1. A method for ordering physically parallel operations in a resource manager (10), in which a plurality of operations is applied by a client application (16, 17, 18) to the resource manager (10), the method comprising:
commencing a transaction between the client application (16, 17, 18) and the resource manager (10);
the resource manager receiving a plurality of operations from the client application (16, 17, 18) in a logical order;
the client application (16, 17, 18) indicating to the resource manager (10) that these operations can be applied in parallel;
the resource manager (10) implementing the operations in parallel;
the resource manager (10) controlling the parallel operations to ensure that the plurality of operations is executed such that the result of the parallel execution is the same as the result that would have been achieved by serial execution in the logical order; and
ending the transaction.

2. A method as claimed in claim 1, wherein the resource manager (10) is a database system and the operations are read, write and update requests.

3. A method as claimed in claim 1, wherein the resource manager is a messaging system and the operations are messaging operations.

4. A method as claimed in claim 1, wherein in certain situations the resource manager (10) completes a first operation before enabling a second operation to commence.

5. A method as claimed in claim 1, wherein on completion of a first operation holding a lock on a given resource, the resource manager (10) controls an unlock of that resource that allows other operations in the same transaction and requiring a conflicting lock on that resource to commence.

6. A method as claimed in claim 1, wherein a conflict between operations can be a physical locking conflict or a logical conflict.

7. A method as claimed in claim 1, wherein locks on any resource hold information on both the transaction and the order of the operation within the logical sequence.

8. A method as claimed in claim 1, wherein if a later operation in the logical order acquires a lock on a given resource before an earlier operation also attempts to acquire a conflicting lock on this resource, the resource manager (10) detects a conflict.

9. A method as claimed in claim 8, where conflict is detected, wherein the resource manager (10) (a) backs out of the later operation but does not back out the earlier operation or other operations within the transaction, (b) grants the lock to the earlier operation, (c) allows the earlier operation to run, and (d) reruns the later operation.

10. A method as claimed in claim 9, wherein the earlier operation is run to completion before the later operation is rerun.

11. A method as claimed in claim 9, wherein the later operation is rerun as soon as the lock has been granted to the earlier operation.

12. A method as claimed in claim 8 where conflict is detected, wherein the resource manager (10) backs out all the work for all the operations in the transaction and reruns all the operations while ensuring that the conflicting operations are run in the correct logical order, wherein any reads can be read from the buffer (14) of the resource manager (10).

13. A method as claimed in claim 8 where conflict is detected, wherein the resource manager (10) backs out of the transaction and reports transaction failure to the client application (16, 17, 18); the client application (16, 17, 18) may then elect to rerun the transaction or take alternative appropriate action.

14. A method as claimed in claim 8, where conflict is detected, wherein if there are repeated conflicts, the resource manager (10) decreases the level of parallelism of operations.

15. A method as claimed in claim 1, wherein execution of the initial read part of each parallel operation prior to its first update part is executed in parallel but update requests are executed in the specified logical order.

16. A method as claimed in claim 15, wherein as much data as possible is read by the resource manager (10) for each operation with a transaction before the update parts of these operations are processed.

17. A method as claimed in claim 1, wherein an asynchronous interface includes a pointer for each operation to an associated control block for reporting status and return information.

18. A method as claimed in claim 17, wherein the results are provided on return from another operation on the same server connection.

19. A method as claimed in claim 1, wherein operation status is reported to the client application (16, 17, 18) using an asynchronous callback or signalling mechanism.

20. Execution of a method as claimed in claim 1, wherein the resource manager (10) is being coordinated with other resource managers by a transaction coordinator.

21. Execution of a method of claim 20, wherein when a resource manager (10) detects a conflict it backs itself out and recovers by retry; but this is not reported to the coordinator, and no backout is executed of the overall transaction, or of the work already done by other coordinated resource managers.

22. A resource manager in which a plurality of operations within a transaction is applied by a client application (16, 17, 18) to the resource manager (10), the resource manager comprising:
receiving means for receiving a plurality of operations from the client application (16, 17, 18) in a logical order, the client application (16, 17, 18) indicating to the resource manager (10) that these operations can be applied in parallel;
means for implementing the operations in parallel and means for controlling the parallel operations to ensure that the plurality of operations is executed such that the result of the parallel execution is the same as the result that would have been achieved by serial execution in the logical order.

23. A resource manager as claimed in claim 22, wherein the resource manager (10) is a database system and the operations are read, write and update requests.

24. A resource manager as claimed in claim 22, wherein the resource manager is a messaging system and the operations are messaging operations.

25. A resource manager as claimed in claim 22, comprising means for, in certain situations, completing a first operation before enabling a second operation to commence.

26. A resource manager as claimed in claim 22 comprising means, responsive to completion of a first operation holding a lock on a given resource, for controlling an unlock of that resource that allows other operations in the same transaction and requiring a conflicting lock on that resource to commence.

27. A resource manager as claimed in claim 22, wherein a conflict between operations can be a physical locking conflict or a logical conflict.

28. A resource manager as claimed in claim 22, wherein locks on any resource hold information on both the transaction and the order of the operation within the logical sequence.

29. A resource manager as claimed in claim 22 comprising means, responsive to a later operation in the logical order acquiring a lock on a given resource before an earlier operation also attempts to acquire a conflicting lock on this resource, for detecting a conflict.

30. A resource manager as claimed in claim 29 comprising means, responsive to detecting conflict, for (a) backing out of the later operation but not backing out the earlier operation or other operations within the transaction, (b) granting the lock to the earlier operation, (c) allowing the earlier operation to run, and (d) rerunning the later operation.

31. A resource manager as claimed in claim 30, wherein the earlier operation is run to completion before the later operation is rerun.

32. A resource manager as claimed in claim 30, wherein the later operation is rerun as soon as the lock has been granted to the earlier operation.

33. A resource manager as claimed in claim 29 comprising means, responsive to conflict being detected, for backing out all the work for all the operations in the transaction and rerunning all the operations while ensuring that the conflicting operations are run in the correct logical order, wherein any reads can be read from the buffer (14) of the resource manager (10).

34. A resource manager as claimed in claim 29 comprising means, responsive to conflict being detected, for backing out of the transaction and reporting transaction failure to the client application (16, 17, 18); the client application (16, 17, 18) may then elect to rerun the transaction or take alternative appropriate action.

35. A resource manager as claimed in claim 29 comprising means, responsive to repeated conflicts being detected, for decreasing the level of parallelism of operations.

36. A resource manager as claimed in claim 22, wherein execution of the initial read part of each parallel operation prior to its first update part is executed in parallel but update requests are executed in the specified logical order.

37. A resource manager as claimed in claim 36, comprising means for reading as much data as possible for each operation with a transaction before the update parts of these operations are processed.

38. A resource manager as claimed in claim 22, wherein an asynchronous interface includes a pointer for each operation to an associated control block for reporting status and return information.

39. A resource manager as claimed in claim 38, wherein the results are provided on return from another operation on the same server connection.

40. A resource manager as claimed in claim 22, wherein an asynchronous call back or signalling mechanism is provided which reports operation status to the client application (16, 17, 18).

41. A resource manager as claimed in claim 22, wherein a transaction coordinator is provided for coordinating the resource manager (10) with other resource managers.

42. A computer program product stored on a computer readable storage medium for ordering physically parallel operations instructed by a client application (16, 17, 18), comprising computer readable program code means for performing the step of:
controlling operations, in a transaction entered into between the client application and a resource manager, said plurality of operations being implemented by the resource manager in parallel, the operations being executed to ensure that the plurality of operations is executed such that the result of the parallel execution is the same as the result that would have been achieved by serial execution in the logical order.
